(19) United States
(12) Patent Application Publication
(10) Pub. No.: US 2009/0225284 A1
(43) Pub. Date: Sep. 10, 2009

(54) PROJECTION LENS MODULE AND OPTICAL PROJECTOR

(75) Inventors: Tzu-Tse Huang, Hsinchu (TW); I-Hsien Liu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/238,452

(22) Filed: Sep. 26, 2008

(30) Foreign Application Priority Data
Mar. 6, 2008 (TW) 97107844

(51) Int. Cl. G03B 3/00; G02B 15/14

(52) U.S. Cl. 353/101; 359/694

(57) ABSTRACT

A projection lens module including a projection lens, a first transmission gear, and an adjusting ring is provided. The projection lens has a lens barrel, a driving ring, and an optical lens module. The driving ring has a plurality of first external teeth and rotates about a first axis. The driving ring is circularly disposed at the lens barrel. The optical lens module is disposed in the lens barrel. When the driving ring rotates, part of the optical lens module moves along the first axis. The first transmission gear has a plurality of second external teeth and rotates about a second axis. The first transmission gear is geared to the driving ring. The adjusting ring has a plurality of first internal teeth and rotates about a third axis. The adjusting ring drives the driving ring through the first transmission gear.

### CROSS-REFERENCE TO RELATED APPLICATION

This application claims the priority benefit of Taiwan application serial no. 97107844, filed on Mar. 6, 2008. The entirety of the above-mentioned patent application is hereby incorporated by reference herein and made a part of this specification.

### BACKGROUND OF THE INVENTION

1. Field of the Invention

The present invention generally relates to a projection lens module, in particular, to a projection lens module applied to an optical projector.

2. Description of Related Art

Current optical projectors, e.g. single beam projectors and liquid crystal display (LCD) projectors, may project images with high definition and high brightness. In addition, the optical projectors have advantages of lower price which is similar to that of the conventional television (TV) sets, small volume, and easy to carry. Therefore, the optical projector is increasingly accepted by most people in the society.

The sizes of a projection screen and the distance of the projection screen relative to a optical projector may be limited by the space of the environment where they are used. Therefore, an adjusting ring for focusing or zooming may be disposed on a projection lens of an optical projector, such that the user may use the adjusting ring to adjust the size or the definition of the image projected by the projection lens.

FIG. 1A is a schematic exploded view of part of components of a conventional projection lens module. FIG. 1B is a schematic assembly view of the projection lens module of FIG. 1A. Referring to FIGS. 1A and 1B, the conventional projection lens module 100 includes a projection lens 110 and a zoom ring 120. The projection lens 110 includes a lens barrel 112, an adjusting pin 114, and an optical lens module 116. The adjusting pin 114 is disposed outside the lens barrel 112, and the optical lens module 116 is disposed in the lens barrel 112. The zoom ring 120 has a sliding slot 122 corresponding to the adjusting pin 114. Before the zoom ring 120 is assembled to the lens barrel 112, the sliding slot 122 is firstly aligned with the adjusting pin 114, for correctly assembling the zoom ring 120 to the lens barrel 112. After the zoom ring 120 is assembled to the lens barrel 112, the zoom ring 120 may rotate relative to the lens barrel 112, and the sliding slot 122 drives the adjusting pin 114 to move along an axis D1, and thus part of the optical lens module 116 moves along the axis D1. Therefore, the rotation of the zoom ring 120 may adjust the size of the image projected by the projection lens 110.

However, due to the limitation of an arc length R of the sliding slot 122, the maximum angle at which the zoom ring 120 rotates is only about 90 degrees. In other words, the adjustment travel of the zoom ring 120 is limited by the arc length R of the sliding slot 122.

### SUMMARY OF THE INVENTION

The present invention provides a projection lens module and an optical projector in which the adjustment travel of the adjusting ring is larger and of which the assembly is easier.

Other advantages and objects of the present invention can be further comprehended through the technical features disclosed in the present invention.

In order to achieve one or part of or all the objectives or other objectives, in an embodiment of the present invention, a projection lens module including a projection lens, a first transmission gear, and an adjusting ring is provided. The projection lens has a lens barrel, a driving ring, and an optical lens module. The driving ring has a plurality of first external teeth and rotates about a first axis. The driving ring is circularly disposed at the lens barrel. The optical lens module is disposed in the lens barrel. When the driving ring rotates, part of the optical lens module moves along the first axis. The first transmission gear has a plurality of second external teeth and rotates about a second axis. The first transmission gear is geared to the driving ring. The adjusting ring has a plurality of first internal teeth and rotates about a third axis. The adjusting ring drives the driving ring through the first transmission gear.

In an embodiment of the present invention, an optical projector including a casing, an illumination system, a light valve, and the above projection lens module is provided. The casing has another opening. The illumination system is disposed in the casing and suitable for emitting an illumination beam. The light valve is disposed in the casing and located in a transmission path of the illumination beam. The light valve is suitable for converting the illumination beam into an image beam. The projection lens module is joined with the casing, and the projection lens of the projection lens module is located in a transmission path of the image beam and suitable for projecting the image beam onto a screen through the other opening above mentioned.

The adjusting ring may drive the driving ring through the first transmission gear, so the adjustment travel of the adjusting ring may be rotated to 360 degrees according to the design requirements. Therefore, the adjustment travel of the adjusting ring is larger. In addition, the adjusting ring is a ring-shaped structure, and the axis of the adjusting ring coincides with the axis of the driving ring, so the manner of assembling the adjusting ring to the projection lens is easier.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings provide a further understanding of embodiments of the invention, and are incorporated in and constitute a part of this specification. The drawings illustrate embodiments of the invention and, together with the description, serve to explain the principles of embodiments of the invention.

FIG. 1A is a schematic exploded view of part of components of a conventional projection lens module.

FIG. 1B is a schematic assembly view of the projection lens module of FIG. 1A.

FIG. 2 is a schematic cross-sectional view of an optical projector according to an embodiment of the present invention.

FIG. 3A is a schematic exploded view of part of components of a projection lens module of FIG. 2.

FIG. 3B is a schematic view illustrating a first transmission gear of FIG. 3A assembled to a projection lens.

FIG. 3C is a schematic assembly view of the projection lens module of FIG. 3A.

FIG. 4 is a schematic view illustrating relative positions of a driving ring, the first transmission gear, and an adjusting ring of FIG. 3A after being assembled.

FIG. 5 is a schematic view illustrating an assembly relationship of part of a fixed ring and the projection lens according to an embodiment of the present invention.

FIG. 6 is a schematic view illustrating a gearing relationship of the driving ring, the first transmission gear, and the adjusting ring according to another embodiment.

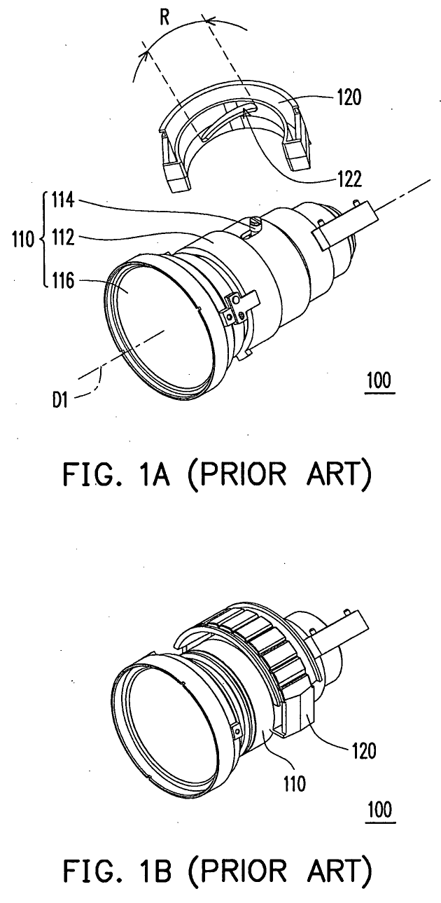

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

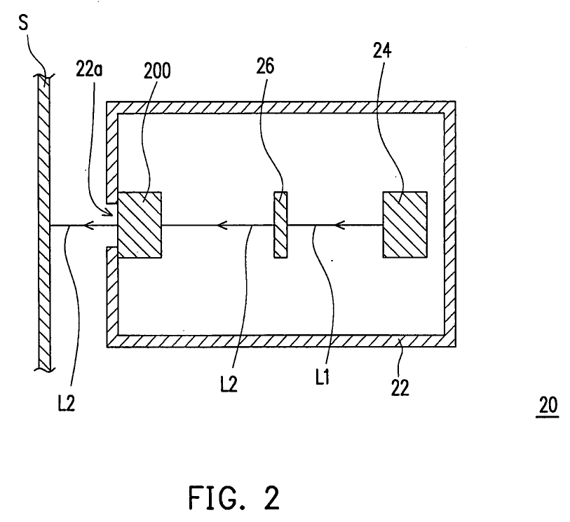

FIG. 2 is a schematic cross-sectional view of an optical projector according to an embodiment of the present invention. Referring to FIG. 2, an optical projector 20 of this embodiment includes a casing 22, an illumination system 24, a light valve 26, and a projection lens module 200. The casing 22 has a first opening 22a, and the illumination system 24 is disposed in the casing 22 and suitable for emitting an illumination beam L1. The light valve 26 is disposed in the casing 22 and located in the transmission path of the illumination beam L1. The light valve 26 is suitable for converting the illumination beam L1 into an image beam L2. The projection lens module 200 is disposed on the casing 22, and is located in the transmission path of the image beam L2. The projection lens module 200 is suitable for projecting the image beam L2 onto a screen S through the first opening 22a.

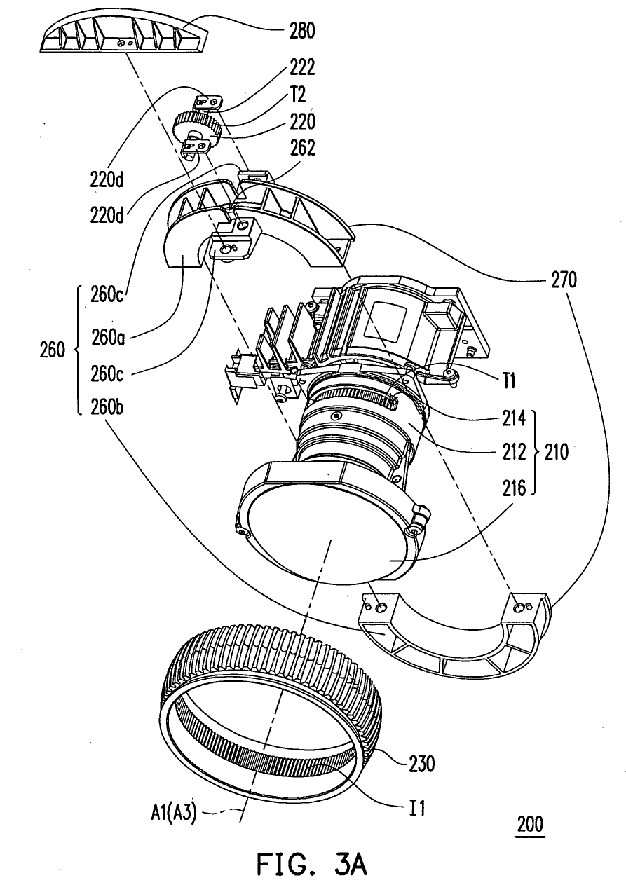

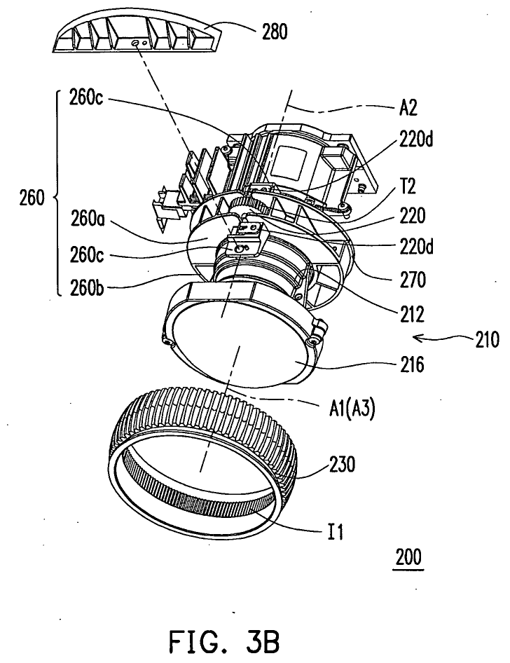

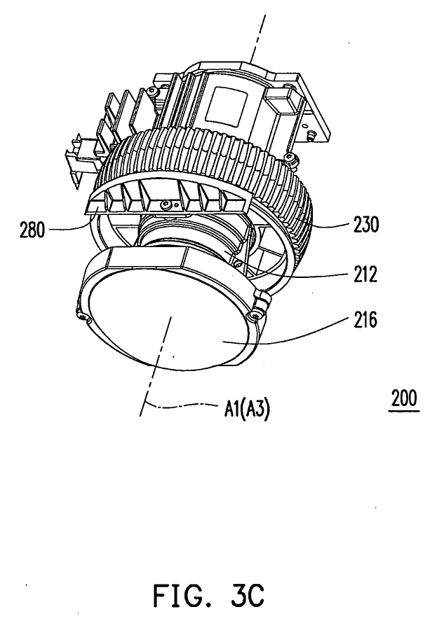

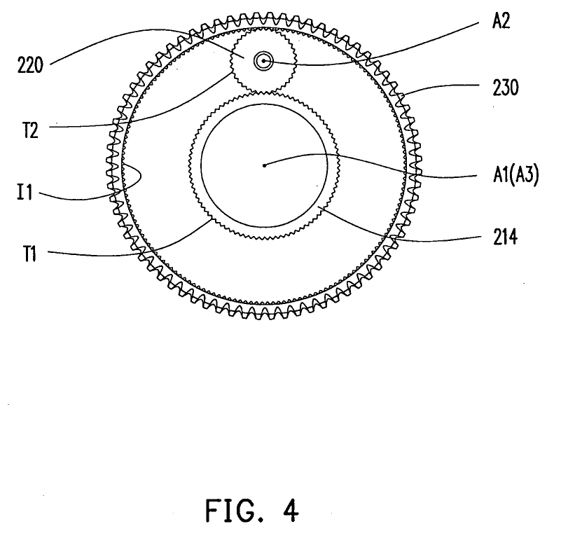

FIG. 3A is a schematic exploded view of part of components of a projection lens module of FIG. 2. FIG. 3B is a schematic view illustrating a first transmission gear of FIG. 3A assembled to a projection lens. FIG. 3C is a schematic assembly view of the projection lens module of FIG. 3A. FIG. 4 is a schematic view illustrating relative positions of a driving ring, the first transmission gear, and an adjusting ring of FIG. 3A after being assembled. Referring to FIGS. 3A, 3B, 3C, and 4, the projection lens module 200 includes a projection lens 210, a first transmission gear 220, and an adjusting ring 230. The projection lens 210 has a lens barrel 212, a driving ring 214, and an optical lens module 216. As far as the arrangement relationship of the driving ring 214 and the optical lens module 216 relative to the lens barrel 212 is concerned, the driving ring 214 is circularly disposed at the lens barrel 212. The optical lens module 216 includes a first lens group and a second lens group, the first lens group includes a plurality of optical lenses disposed in the lens barrel 212 and the second lens group includes a plurality of other optical lenses disposed in the lens barrel 212.

Further, the driving ring 214 has a plurality of first external teeth T1 and rotates about a first axis A1. When the driving ring 214 rotates, part of the optical lens module 216 moves along the first axis A1. In detail, when the driving ring 214 is a focus ring and rotates about the first axis A1, the focus ring may drive the first lens group to move along the first axis A1, so as to change the focusing state of the projection lens 210. If the driving ring 214 is a zoom ring and rotates about the first axis A1, the zoom ring may drive the second lens group to move along the first axis A1, so as to zoom out or zoom in an image projected by the projection lens 210.

The first transmission gear 220 has a plurality of second external teeth T2. The first transmission gear 220 rotates about a second axis A2, and the first transmission gear 220 is geared to the driving ring 214. The adjusting ring 230 has a plurality of first internal teeth I1 and rotates about a third axis A3, and the adjusting ring 230 may drive the driving ring 214 through the first transmission gear 220. In this embodiment, the first axis A1 coincides with the third axis A3, and the first axis A1 is parallel to the second axis A2. The first internal teeth I1 of the adjusting ring 230 is geared to the second external teeth T2 of the first transmission gear 220. The second external teeth T2 of the first transmission gear 220 is geared to the first external teeth T1 of the driving ring 214. In addition, at least part of the first transmission gear 220 is located between the adjusting ring 230 and the driving ring 214.

The adjusting ring 230 may drive the driving ring 214 through the first transmission gear 220, so the adjustment travel of the adjusting ring 230 may be designed to rotate in a range of 0 degrees to 360 degrees as required. Therefore, as compared with the prior art, the adjustment travel of the adjusting ring 230 of this embodiment is larger. In addition, the adjusting ring 230 is a ring-shaped structure, and the first axis A1 coincides with the third axis A3. Thus, as compared with the prior art, the manner of assembling the adjusting ring 230 to the projection lens 210 is easier.

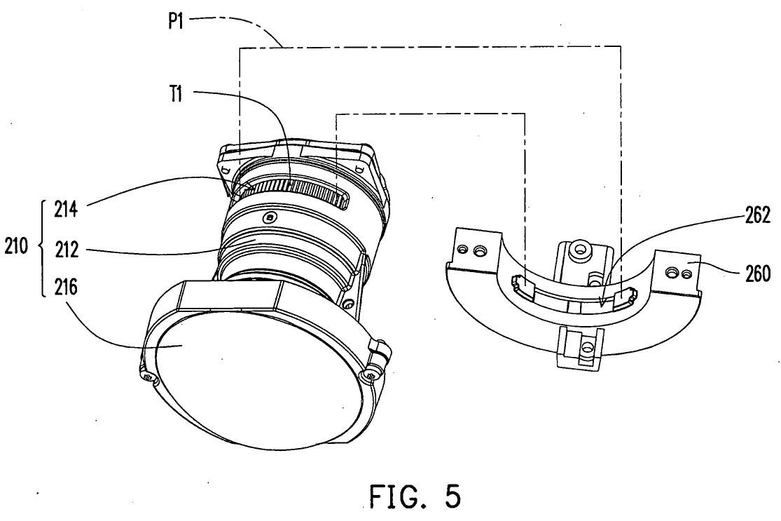

In this embodiment, the projection lens module 200 further includes a fixed ring 260. The fixed ring 260 is fixed at the lens barrel 212, and the first transmission gear 220 is axially disposed at the fixed ring 260. FIG. 5 is a schematic view illustrating an assembly relationship of part of a fixed ring and the projection lens according to an embodiment of the present invention. Referring to FIGS. 3A, 3B, and 5, the fixed ring 260 of this embodiment includes a top base 260a, a bottom base 260b, and two fixing bases 260c. In addition, the fixed ring 260 has a second opening 262 located at the top base 260a. The top base 260a and the bottom base 260b may be assembled to be circularly disposed at the lens barrel 212. When the top base 260a is embedded into the lens barrel 212 along an assembling path P1 in FIG. 5, the second opening 262 exposes at least part of the first external teeth T1 of the driving ring 214. In addition, the fixing bases 260c are respectively fixed at two opposite sides of the top base 260a. Two fixing elements 220d of the first transmission gear 220 may be respectively screwed at the fixing bases 260c, such that a bearing 222 of the first transmission gear 220 is positioned on the top base 260a. In addition, the first transmission gear 220 is geared to driving ring 214 through the second opening 262.

Referring to FIGS. 3B and 3C, in this embodiment, the projection lens module 200 further includes a limit ring 270 and a limit element 280. The limit ring 270 is circularly disposed and fixed at the fixed ring 260, and the limit element 280 is fixed outside the lens barrel 212. In this embodiment, the limit ring 270 and the fixed ring 260 are integrally formed, and the limit element 280 is fixed at one of the fixing bases 260c of the fixed ring 260. Thus, part of the first internal teeth I1 of the adjusting ring 230 is limited between the limit ring 270 and the limit element 280. Therefore, the adjusting ring 230 does not easily become loose along the third axis A3.

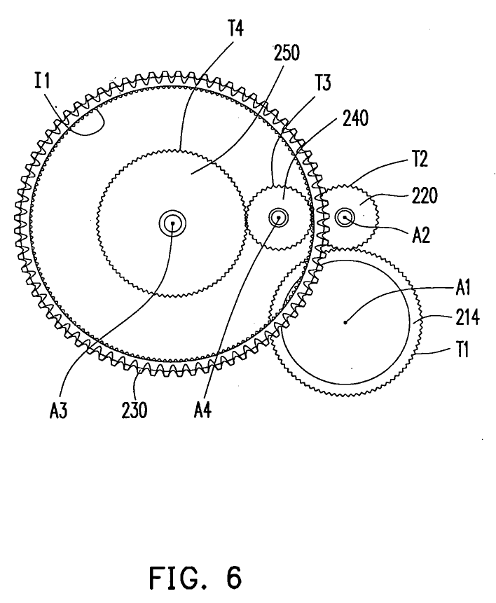

FIG. 6 is a schematic view illustrating a gearing relationship of the driving ring, the first transmission gear, and the adjusting ring according to another embodiment. In another embodiment, the projection lens module 200′ further includes a second transmission gear 240 and a third transmission gear 250. The second transmission gear 240 has a plurality of third external teeth T3, and the second transmission gear 240 rotates about a fourth axis A4. The first axis A1, the second axis A2, the third axis A3, and the fourth axis A4 are parallel to one another, and the second transmission gear 240 is geared to the first transmission gear 220 and the adjusting ring 230. The third transmission gear 250 has a plurality of fourth external teeth T4 and rotates about the third axis A3. The third transmission gear 250 is geared to the second transmission gear 240.

In detail, at least part of the second transmission gear 240 is located between the adjusting ring 230 and the third transmission gear 250. When the adjusting ring 230 rotates, the first internal teeth I1 of the adjusting ring 230 drive the third external teeth T3 of the second transmission gear 240. The third external teeth T3 of the second transmission gear 240 then drives the second external teeth T2 of the first transmission gear 220. The second external teeth T2 of the first transmission gear 220 then drives the first external teeth T1 of the driving ring 214.

To sum up, the projection lens module and the optical projector of the embodiments of the present invention at least have one of the following advantages.

1. The adjusting ring may drive the driving ring through the first transmission gear, so the adjustment travel of the adjusting ring may be designed to rotate to 360 degrees as required. Therefore, as compared with the prior art, the adjustment travel of the adjusting ring of the embodiment is larger.

2. The adjusting ring is a ring-shaped structure, and the axis of the adjusting ring may coincide with the axis of the driving ring. Therefore, as compared with the prior art, the manner of assembling the adjusting ring to the projection lens according to the above embodiments is easier, thus increasing the convenience for the user.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection lens module, comprising:
a projection lens, comprising a lens barrel, a driving ring, and an optical lens module, wherein the driving ring circularly disposed at the lens barrel comprises a plurality of first external teeth and rotates about a first axis, the optical lens module is disposed in the lens barrel, and part of the optical lens module moves along the first axis when the driving ring rotates;
a first transmission gear, comprising a plurality of second external teeth, wherein the first transmission gear is geared to the driving ring and rotates about a second axis; and
an adjusting ring, comprising a plurality of first internal teeth and rotating about a third axis, wherein the adjusting ring drives the driving ring through the first transmission gear.

2. The projection lens module according to claim 1, wherein the first axis coincides with the third axis, the first axis is parallel to the second axis, the first transmission gear is geared to the adjusting ring, and at least part of the first transmission gear is located between the adjusting ring and the driving ring.

3. The projection lens module according to claim 2, further comprising:
a fixed ring, fixed at the lens barrel and comprising an opening for exposing at least part of the first external teeth, wherein the first transmission gear is axially disposed at the fixed ring and geared to the driving ring through the opening.

4. The projection lens module according to claim 3, further comprising:
a limit ring, circularly disposed and fixed at the fixed ring; and
a limit element, fixed outside the lens barrel, wherein part of the first internal teeth of the adjusting ring is limited between the limit ring and the limit element.

5. The projection lens module according to claim 3, wherein the first transmission gear further comprises a plurality of fixing elements, the fixed ring further comprises a plurality of fixing bases, and the fixing elements are respectively fixed at the fixing bases, such that the first transmission gear is positioned at the fixed ring.

6. The projection lens module according to claim 1, further comprising:
a second transmission gear, comprising a plurality of third external teeth and rotating about a fourth axis, wherein the first axis, the second axis, the third axis, and the fourth axis are parallel to one another, and the second transmission gear is geared to the first transmission gear and the adjusting ring; and
a third transmission gear, comprising a plurality of fourth external teeth, wherein the third transmission gear is geared to the second transmission gear and rotates about the third axis, and at least part of the second transmission gear is located between the adjusting ring and the third transmission gear.

7. An optical projector, comprising:
a casing, comprising a first opening;
an illumination system, disposed in the casing and suitable for emitting an illumination beam;
a light valve, disposed in the casing and located in a transmission path of the illumination beam, wherein the light valve is suitable for converting the illumination beam into an image beam; and
a projection lens module, joined with the casing, wherein the projection lens module comprises:
a projection lens, located in a transmission path of the image beam and suitable for projecting the image beam onto a screen through the first opening, wherein the projection lens has a lens barrel, a driving ring, and an optical lens module, the driving ring comprises a plurality of first external teeth and rotates about a first axis, the driving ring is circularly disposed at the lens barrel, the optical lens module is disposed in the lens barrel, and part of the optical lens module moves along the first axis when the driving ring rotates;
a first transmission gear, comprising a plurality of second external teeth and rotating about a second axis, wherein the first transmission gear is geared to the driving ring; and
an adjusting ring, comprising a plurality of first internal teeth and rotating about a third axis, wherein the adjusting ring drives the driving ring through the first transmission gear.

8. The optical projector according to claim 7, wherein the first axis coincides with the third axis, the first axis is parallel to the second axis, the first transmission gear is geared to the adjusting ring, and at least part of the first transmission gear is located between the adjusting ring and the driving ring.

9. The optical projector according to claim 8, wherein the projection lens module further comprises:
a fixed ring, fixed at the lens barrel and comprising a second opening for exposing at least part of the first external teeth, wherein the first transmission gear is axially disposed at the fixed ring and geared to the driving ring through the second opening.

10. The optical projector according to claim 9, wherein the projection lens module further comprises:
a limit ring, circularly disposed and fixed at the fixed ring; and
a limit element, fixed outside the lens barrel, wherein part of the first internal teeth of the adjusting ring is limited between the limit ring and the limit element.

11. The optical projector according to claim 9, wherein the first transmission gear further comprises a plurality of fixing elements, the fixed ring further comprises a plurality of fixing bases, and the fixing elements are respectively fixed at the fixing bases, such that the first transmission gear is positioned at the fixed ring.

12. The optical projector according to claim 7, wherein the projection lens module further comprises:
a second transmission gear, comprising a plurality of third external teeth and rotating about a fourth axis, wherein the first axis, the second axis, the third axis, and the fourth axis are parallel to one another, and the second transmission gear is geared to the first transmission gear and the adjusting ring; and
a third transmission gear, comprising a plurality of fourth external teeth, wherein the third transmission gear is geared to the second transmission gear and rotates about the third axis, and at least part of the second transmission gear is located between the adjusting ring and the third transmission gear.
